(19) United States
(12) Patent Application Publication
(10) Pub. No.: US 2009/0048790 A1
(43) Pub. Date: Feb. 19, 2009

(54) System for Determining a Vehicle Load

(76) Inventors: Thomas Dermot Geraghty, Dublin (IE); Biswajit Basu, Dublin (IE)

Correspondence Address: JACOBSON HOLMAN PLLC, 400 SEVENTH STREET N.W., SUITE 600, WASHINGTON, DC, 20004, US

(21) Appl. No.: 12/224,894

(22) PCT Filed: Mar. 9, 2007
(86) PCT No.: PCT/IE2007/000032

§ 371 Date: Sep. 9, 2008

(30) Foreign Application Priority Data
Mar. 10, 2006 (IE) 2006/0184

(51) Int. Cl. G01L 5/00; G01G 19/08

(52) U.S. Cl. 702/42; 177/136

(57) ABSTRACT

A system (1) for determining a load of a vehicle such as a HGV. The system (1) comprises a plurality of strain gauges (2) mounted on each axle (3, 4) of the HGV. Each strain gauge (2) is arranged parallel to the longitudinal axis A-A of the axles (3, 4) to measure the strain exerted on each axle (3, 4) in a direction substantially parallel to the longitudinal axis A-A of each axle (3, 4). The strain gauges (2) are mounted on the axles (3, 4) at locations on the axles (3, 4) at which the axles (3, 4) exhibit a substantially linear strain-load relationship. These locations are determined, by performing a finite element analysis of the axles (3, 4). The system (1) also comprises a master control unit (5), carried on-board the HGV5 for calculating the HGV load responsive to the longitudinal strain measured by the strain gauges (2). The load exerted by the HGV on the road surface may then be calculated responsive to the calculated HGV load. The strain gauges (2) may be employed to measure in real-time the longitudinal strain exerted on the nodes (3, 4) of the HGV while the HGV is moving, and the master control unit (5) may be employed to calculate in real-time the HGV load while the HGV is moving. The system (1) further comprises a transmitter for transmitting information from the HGV to a central server at a location remote from the HGV.

### INTRODUCTION

This invention relates to a system for determining a vehicle load and to a method of determining a vehicle load. This invention is particularly suitable for determining the load of a heavy goods vehicle (HGV).

A considerable amount of time and money is spent annually on repair and maintenance of roads internationally. Axle loads (forces) transmitted by a vehicle to a road are known to cause damage to the road surface. It is known that heavy goods vehicles cause the majority of road damage. This axle-force or load has two components; a static component, which is determined by the weight of the vehicle plus the payload, and a dynamic component, evident when the vehicle is in motion. The dynamic component is time dependent and is driven by excitation sources external to the vehicle, for example road surface roughness.

This invention is aimed at providing a system and method for determining a vehicle load, in one particular case for determining a vehicle load while the vehicle is in motion.

### STATEMENTS OF INVENTION

According to the invention there is provided a system for determining a vehicle load, the system comprising:—
means to measure strain exerted on at least one axle of a vehicle; and
responsive to the measured strain, means to calculate the vehicle load.

By calculating the vehicle load, the force exerted by the vehicle on a road may be determined, and thus the damage caused to the road by the vehicle may be estimated. In this manner road management authorities may observe the extent of damage caused to a road by different types of vehicles.

In one embodiment of the invention the measuring means is configured to measure strain exerted on at least one vehicle axle in a direction substantially parallel to the longitudinal axis of the at least one vehicle axle. Preferably the measuring means is configured to be mounted on at least one vehicle axle. Ideally the measuring means is configured to be mounted on at least one vehicle axle at one or more locations on the at least one vehicle axle at which the at least one vehicle axle exhibits a substantially linear strain-load relationship. Because of the linear strain-load relationship, the vehicle load may be calculated directly from the axle strain. In particular complex conversion calculations and calibration calculations are not required to calculate the vehicle load.

When the strain-load relationship is linear, for example of the form:

force=k*strain+c

where k and c are constants;
computation of the force is relatively simple if k and c are known. Thus a low cost microprocessor is able to handle this calculation. Most preferably the system comprises means to determine one or more locations on a vehicle axle at which the vehicle axle exhibits a substantially linear strain-load relationship. The determining means may be configured to perform finite element analysis of a vehicle axle to determine one or more locations on the vehicle axle at which the vehicle axle exhibits a substantially linear strain-load relationship. Preferably the determining means is configured to perform finite element analysis of a vehicle axle to determine strain distribution in the vehicle axle. Ideally the determining means is configured to use 3-D finite element modelling of a vehicle axis.

In one case the measuring means comprises one or more strain gauges. Preferably the measuring means comprises a first strain gauge configured to be mounted on one side of a vehicle axle and a second strain gauge configured to be mounted on an opposite side of the vehicle axle.

In another embodiment the measuring means is configured to measure the strain exerted on at least one axle of a moving vehicle, and the calculating means is configured to calculate the moving vehicle load. The measuring means may be configured to measure in real-time strain exerted on at least one vehicle axle. The calculating means may be configured to calculate in real-time vehicle load.

In one case the measuring means is configured to measure strain exerted on at least one axle of a stationary vehicle, and the calculating means is configured to calculate the stationary vehicle load.

The calculating means may be configured to be carried on board a vehicle.

In one embodiment the system comprises means to receive vehicle speed data and for relating it to load data. Preferably the system comprises means to receive vehicle location data and for relating it to load data.

The calculating means may be configured to be located remote from a vehicle, the system may comprise a wireless transmitter for transmitting strain data, and the calculating means may comprise a wireless interface to receive strain data. The system may comprise means to transmit information including vehicle lead data from a vehicle to a location remote from the vehicle. Most preferably the information includes vehicle speed information The information may include vehicle location information.

Calculations of force may be made in situ by the WIM node. Alternatively the strain values may be simply transmitted to a remote computer to complete the calculation. However, the algorithm requires averaging strain measurements overtime in order to determine the mean strain. It is therefore more economical to calculate the force in situ from an average of a large number of strain measurements than to transmit a large number of strain values via GSM or some other equivalent means. In essence data reduction reduces communications cost.

In one embodiment the calculating means is configured to calculate the vehicle load based on a finite element analysis of at least one vehicle axle. Preferably calculating means is configured to calculate the vehicle load by accessing a predetermined database of load values versus strain values. Ideally the system comprises means to perform finite element analysis of a vehicle axle to populate the database of load values versus strain values.

Linear strain-load behaviour allows a look up table (LUT) approach to be employed whereby a small number of coarse strain values may be used to make a rough estimate of force; this estimate may then be refined by interpolation between adjacent values in the LUT. This approach is computationally cheap, that is a low cost microprocessor may perform the calculation and the calculation may be performed quickly. A non-linear relationship between force and strain would make this calculation more difficult because the relationship would be difficult to establish.

Furthermore, once the linear relationship between force and strain is known for a particular truck, it should be possible to use the same data for other trucks of the same model.

The calculating means may be configured to calculate the vehicle load by means of a predetermined relationship between load and strain. Preferably the system comprises means to perform finite element analysis of a vehicle axle to obtain the relationship between load and strain.

In one case the system comprises means to calculate, responsive to the calculated vehicle load, the load exerted by a vehicle on a road surface.

In another aspect the invention provides a vehicle assembly comprising:—
a vehicle; and
a system for determining the vehicle load of the invention.

In a further aspect the invention provides a vehicle assembly comprising:—
a vehicle; and
a system for determining the vehicle load, the system comprising means to measure strain exerted on at least one axle of the vehicle;
the measuring means comprising a first strain gauge configured to be mounted on one side of the vehicle axle and a second strain gauge configured to be mounted on an opposite side of the vehicle axle.

The invention further provides in a further aspect a method of determining a vehicle load, the method comprising the steps of:—
measuring strain exerted on at least one axle of the vehicle; and
responsive to the measured strain, calculating the vehicle load.

In one aspect of the invention the strain exerted on the at least one vehicle axle in a direction substantially parallel to the longitudinal axis of the at least one vehicle axle is measured.

The method may comprise the step of mounting a measuring means on the at least one vehicle axle. Preferably the measuring means is mounted on the at least one vehicle axle at one or more locations on the at least one vehicle axle at which the at least one vehicle axle exhibits a substantially linear strain-load relationship. Ideally the method comprises the step of determining the one or more locations on the at least one vehicle axle at which the at least one vehicle axle exhibits a substantially linear strain-load relationship. Most preferably a finite element analysis of the at least one vehicle axle is performed to determine the one or more locations on the at least one vehicle axle at which the at least one vehicle axle exhibits a substantially linear strain-load relationship.

The vehicle may be moving. The strain exerted on the at least one-vehicle axle may be measured in real-time. The vehicle load may be calculated in real-time.

In another case the vehicle is stationary. The vehicle load may be calculated on board the vehicle. The vehicle load may be calculated at a location remote from the vehicle. The method may comprise the step of transmitting information from the vehicle to a location remote from the vehicle. Preferably the measured strain information is transmitted. Ideally vehicle load information is transmitted. Most preferably the vehicle speed information is transmitted. The vehicle location information may be transmitted.

In another embodiment the vehicle load is calculated based on a finite element analysis of the at least one vehicle axle. Preferably the vehicle load is calculated by accessing a predetermined database of load values versus strain values. Ideally the method comprises the step of performing a finite element analysis of the at least one vehicle axle to populate the database of load values versus strain values.

The vehicle load may be calculated by means of a predetermined relationship between load and strain. Preferably the method comprises the step of performing a finite element analysis of the at least one vehicle axle to obtain the relationship between load and strain.

The method may comprise the step of calculating, responsive to the calculated vehicle load, the load exerted by the vehicle on a road surface.

The system of the invention may be employed to determine a moving vehicle load, or a stationary vehicle load.

The road surface roughness is the excitation which gives rise to the dynamic component of the force acting on the road via the vehicle suspension. The mean of this force is the static component of force. The road surface roughness may be modelled as a homogenous, isotropic and Gaussian random process. In essence, what this means is that the statistics of the road surface roughness are unvarying. An averaging technique may be used to estimate the mean strain from the measured responses of the strain on the axle of a vehicle. The static load acting on the vehicle may be obtained from the estimated mean strain and compared with the actual load. In particular a record of strain samples may be averaged or integrated to find the mean strain and thus the static component of force. This may be done while the vehicle is in motion.

The vehicle load may be calculated on board the vehicle or at a remote location, such as a central server. The vehicle speed, load, location may all be monitored at the central server.

The system of the invention provides a number of advantageous effects including:
determination of the static axle load of a vehicle while the vehicle is in motion;
using vehicle mounted instrumentation to determine static load;
using measurements of axle strain to determine the axle load;
using strain gauge transducers to transduce axle strain;
using measurements of longitudinal strain to determine axle strain;
using axle load measurements to determine static vehicle load;
using axle load measurements to determine axle load transmitted to road surface;
solving the inverse strain-force problem to determine the load from measurements of strain;
use of 3-D Finite Element modelling to determine the strain distribution in an axle housing in order to find the optimum locations to site strain transducers;
use of Finite Element modelling to determine absolute strain levels at specific sites on the axle;
using multiple data acquisition nodes to digitize strain levels;
connecting WIM nodes using a Controller Area Network bus to fleet management controller;
off line calculation of the axle loads and vehicle weight and load distribution from axle strain data provided to a central server via a communications link.

The invention provides a system for real-time weigh in motion of heavy goods vehicles (HGVs). The system is suitable for application in:
road damage estimation;
road pricing by weight;
prevention of inadvertent overloading of vehicles;
aiding fleet managers to prevent fraud;
determining the load distribution on the vehicle and alerting the driver if the load shifts dangerously in transit.

The system of the invention has a number of advantageous aspects including:
providing real-time measurements of the load on each axle of the truck using a measuring instrument on board the truck;
finite element models of truck axles are used to predict the strain distribution in the axles. Optimum locations for the position of strain measuring transducers, such as strain gauges, are determined in this manner;
the relationship between strain and applied load is also predicted using Finite Element Analysis (FEA);
anticipated strain range is also determined using FEA;
a relationship between applied load and strain is predicted using FEA;
each axle is instrumented with strain measuring devices and the strain is digitized locally by a microprocessor based data logger;
the data loggers are networked using a Controller Area Network (CAN) bus and interfaced to a main controller;
the main controller connects to a fleet management system;
load data may be transmitted to a remote server via a GPS link or the load data can be processed and displayed locally or both;
both static and dynamic load measurements are possible;
static loads can be determined while the vehicle is in motion.

The system of the invention may be used to measure, in real time, the strain in the axles of HGV's. This strain information may be used in conjunction with finite element models of the axle to calculate the axle load, and the static and dynamic forces transmitted to a road surface. These measurements of static and dynamic forces may be used to estimate a contribution to overall road damage. This data may be used as part of a weight (load) and distance based road-pricing mechanism.

The force measurement system may be vehicle based in contrast to fixtures such as weighbridges. The system may include real time vehicle tracking using GPS and a Geographical Information System (GIS). The system may be interrogated via a GSM link.

The static load carried by heavy goods vehicle may be estimated on a real time basis. Axial strain time histories of the vehicle axle are measured at some key locations and an inverse problem is solved to estimate the mean load on the axle. The optimal measurement points are determined based on the criterion of the measurability of the strain. The time histories are random due to the excitation by the road surface roughness or vertical irregularities and with a non-zero mean due to the static load. The inverse problem is based on finite element modelling of the axle of the vehicle to relate the mean load to the axial strain. For this purpose, the axle of the heavy goods vehicle has in one case been modelled using a 20-node shell element to capture the 3-D curved geometry properly. This finite element model of the axle was updated based on the experimental measured response of the axle in the laboratory using both static and cyclic dynamic loading. Based on the measured axial strain, time histories of the axle of the original vehicle is measured and mean strains are estimated by stochastic averaging the dynamic response over the measured time span. Based on this mean strain, the load carried by the vehicle is estimated. An important feature is that the static load may be determined at any time whether the vehicle is in motion or not.

Strains may be measured using resistance strain gauges organized in a DC Wheatstone Bridge. The bridge excitation is a constant current type. Strain levels are digitized locally using a sigma-delta analog to digital converter. All strain gauge measurements are communicated to the central controller on the vehicle over a CAN bus network. This central controller (fleet management system) incorporates GPS and is interrogated from a remote base station using a GSM link. The raw data measured at the axles are used to drive an FE model of the axle and this model is used to determine the instantaneous loads on the axle and may be used, for example, to calculate a road pricing charge.

The invention provides a method and apparatus for real time weigh in motion of heavy goods and other vehicles.

The invention enables the forces transmitted to a road surface via the axles of a Heavy Goods Vehicle to be measured in real time while the vehicle is either stationary or in motion. Thus it is possible to determine the load on the vehicle and the load distribution. In addition, the location of the vehicle on the road network is also available and thus the forces transmitted can be correlated with the condition of the road and the speed of the vehicle. Load and position data may be transmitted periodically to a central server via a GSM link, which then determines the vehicles position from the transmitted GPS data using a Geographical Information System (GIS).

Instrumentation measures the strain in the vehicle axles at a number of locations and uses this strain information to determine the applied load. The system includes a number of measurement nodes, one per axle, connected together via a Controller Area Network (CAN), which in turn are controlled by a COTS fleet management system, which provides the GPS and GSM connectivity to a remote server.

Finite element modelling may be used to determine optimum locations for the strain sensors and also the strain range expected for each axle type. The information provided by the finite element modelling determines the relationship between the applied load and strain and from this information the so-called inverse problem can be solved i.e. the applied load can be determined from the strain measurements. The modelling was verified with a combination of laboratory experiments on actual axles and by instrumenting a vehicle.

The device may operate over the automotive temperature range.

The invention measures the axle forces transmitted to the road surface by a vehicle while it is in motion. It may determine the static and the dynamic loads. It is installed in the vehicle and the load can be determined at any point along the road network.

The invention determines the load by measuring longitudinal strains in the axle and relating the strains to the applied load. This is the inverse of the normal situation where known loads are applied and strain measured. The expected level of strain, the strain per unit load and the locations of the regions of highest strain and no axle distortion are determined by finite element analysis. The FE models can be easily modified to cater for different sizes and configurations of axles.

For both static and dynamic load prediction, the model is excited with a road surface profile. This road surface is modelled as a homogenous, isotropic and random process. Axle end displacements and suspension forces are estimated from 2-dimension half car model. Using the displacement and force time histories from the 2-D model, the axial strain response of a 3-D axle is calculated. Using data determined experimentally from tests on an actual axle the model is further refined to improve accuracy. The model can then predict loading to within about 1.5% from strain measurements.

Instrumentation is fitted on the vehicle. This instrumentation measures strain at locations determined by the FE modelling and communicates it to a central controller, which correlates it with GPS and GIS data. Thus axle-loading data can be related to the position of the vehicle on the road network.

### BRIEF DESCRIPTION OF THE DRAWINGS

The invention will be more clearly understood from the following description of an embodiment thereof, given by way of example only, with reference to the accompanying drawings, in which:—

FIG. 1 is a schematic illustration of a system for determining a vehicle load according to the invention;

FIG. 2 is an illustration of a finite element model of an axle of a vehicle showing strain distribution;

FIG. 3 is a graph of strain in a longitudinal direction versus payload for a static analysis;

FIG. 4 is a graph of strain in a vertical direction versus payload for a static analysis; and

FIG. 5 is an illustration of strain levels in a longitudinal direction.

### DETAILED DESCRIPTION

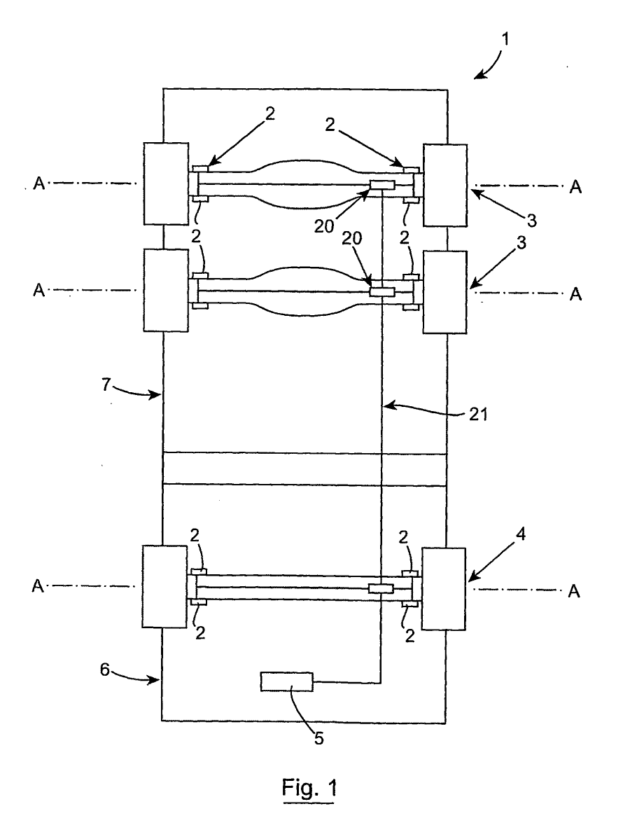

Referring to the drawings and initially to FIG. 1 thereof, there is illustrated a system 1 according to the invention for determining a vehicle load. The system 1 is particularly suitable for determining a load of a vehicle such as a HGV. In this case the HGV comprises a cab 6 and a trailer unit 7. The cab 6 has one front steering axle 4, and the trailer unit 7 has two rear drive axles 3. Together the system 1 and the HGV provide a vehicle assembly according to the invention.

The system 1 may be fitted to a vehicle, such as the HGV, during manufacture or alternatively the system 1 may be retrofitted to a previously manufactured vehicle.

The system 1 comprises a plurality of strain gauges 2 mounted on each axle 3, 4 of the HGV. In particular four strain gauges 2 are mounted on each axle 3, 4 in this case. A pair of strain gauges 2 is mounted at each end of each axle 3, 4. Each pair of strain gauges 2 is arranged with a strain gauge 2 on one side of the axle 3, 4 and the other strain gauge 2 on the opposite side of the axle 3, 4.

Each strain gauge 2 is arranged parallel to the longitudinal axis A-A of the axles 3, 4. In this manner the strain gauges 2 are employed to measure the strain exerted on each axle 3, 4 in a direction substantially parallel to the longitudinal axis A-A of each axle 3, 4.

The strain gauges 2 are mounted on the axles 3, 4 at locations on the axles 3, 4 at which the axles 3, 4 exhibit a substantially linear strain-load relationship. These locations are determined, for example, by performing a finite element analysis of the axles 3, 4.

The system 1 also comprises a master control unit 5, carried on-board the HGV, for calculating the HGV load. The master control unit 5 is connected to the strain gauges 2, and the HGV load is calculated by the master control unit 5 responsive to the longitudinal strain measured by the strain gauges 2. In this case the master control unit 5 accesses a predetermined database or look-up table of load values versus strain values to calculate the HGV load based on the longitudinal strain measured by the strain gauges 2. The load exerted by the HGV on the road surface may then be calculated responsive to the calculated HGV load.

The database or look-up table of load values versus strain values may be populated by performing a finite element analysis of the axles 3, 4. Typically this finite element analysis is performed prior to fitting of the system 1 to a vehicle.

The system 1 of the invention is depicted in FIG. 1. Strain transducers 2, such as resistance strain gauges or semi-conductor gauges or other, are mounted in pairs on both sides of each axle 3, 4 at locations determined using a finite element model of the axle 3, 4. These strain transducers 2 detect the strain and transducer it to a voltage and are arranged in a Wheatstone Bridge with two active arms. A measurement node 20, referred to herein as a Weigh in Motion (WIM) node, is located as close as possible to the strain gauges 2. The WIM node 20 digitizes the voltage output from the strain gauge bridges and stores it in memory.

The WIM nodes 20 are connected together using a Controller Area Network 21 (CAN) and also connected to the master control unit 5, which can be a fleet management system, a PC or other device with CAN capability. The master control unit 5 uses the CAN bus to control the individual WIM nodes 20 and read the strain measurements from the WIM nodes 20. The vehicle load is calculated using a lookup table of strain versus load generated from the finite element analysis of the axles 3, 4.

The use of CAN allows the WIM system to be integrated with existing vehicle instrumentation. It is envisaged that the controller would be a fleet management system with GPS capability, connected to a central server via GSM. This central server would then be able to correlate position and load data using a Geographical Information System (GIS).

The strain gauges 2 may be employed to measure in real-time the longitudinal strain exerted on the nodes 3, 4 of the HGV while the HGV is moving, and the master control unit 5 may be employed to calculate in real-time the HGV load while the HGV is moving. Alternatively the strain gauges 2 may be employed to measure in real-time the longitudinal strain exerted on the axles 3, 4 of the HGV while the HGV is stationary, and the master control unit 5 may be employed to calculate in real-time the HGV load while the HGV is stationary.

The system 1 further comprises a transmitter for transmitting information from the HGV to a central server at a location remote from the HGV. The information transmitted from the HGV to the central server may be information on the HGV load calculated by the master control unit 5, or information on the speed of the HGV, or information on the location of the HGV.

In use a finite element analysis of the HGV axles 3, 4 is performed to populate the database or look-up table of load values versus strain values. In addition a finite element analysis of the HGV axles 3, 4 is performed to determine the locations on the axles 3, 4 at which the axles 3, 4 exhibit a substantially linear strain-load relationship. The strain gauges 2 are then mounted on the axles 3, 4 at these locations.

The strain gauges 2 measure in real-time the longitudinal strain exerted on the axles 3, 4 while the HGV is stationary or moving. These measured strains are provided to the master control unit 5.

Using the measured strains, the master control unit 5 accesses the database or look-up table of load values versus strain values to calculate in real-time the HGV load, for either a stationary or moving HGV.

The transmitter transmits the load information, and/or the speed information, and/or the location information of the HGV from the HGV to the central server.

The location of the strain sensors 2 is important for the optimum operation of the system 1. The objective is to site the transducers 2 where the relationship between strain and applied load is linear over the load range of interest, to achieve the maximum sensitivity and to avoid locations where the axle 3, 4 may suffer distortion under load and thus cause the strain transducer 2 to become detached from the axle surface.

### EXAMPLE

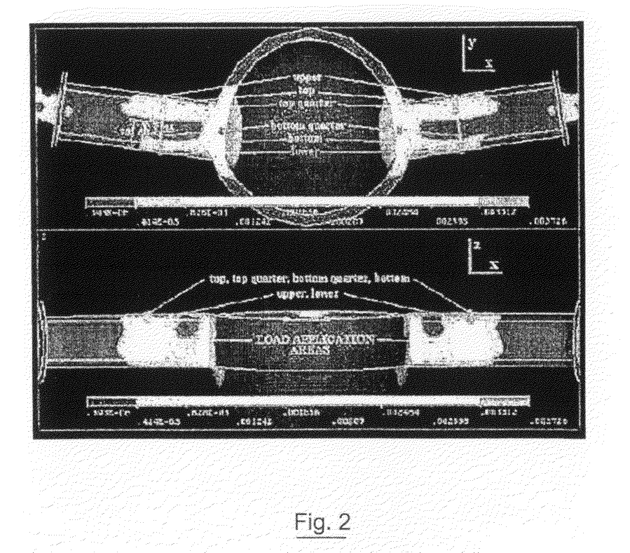

A finite element analysis (FEA) of a truck axle from a DAF tractor unit was carried out and the strain distribution determined is shown in FIG. 2.

The strain intensity plot highlighted three areas of high strain in the structure, one directly-beneath the point of application of the load and the others at the quarter points on the front face of the axle arm directly beneath the point of load application. Placing the strain gauges 2 directly beneath the point of load application may be impractical. Instead further investigation was performed focussing on the strain distribution within the front wall.

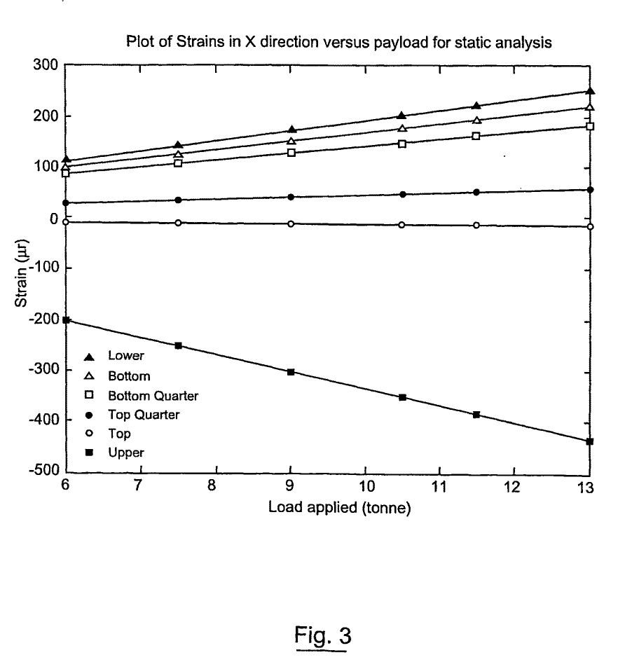

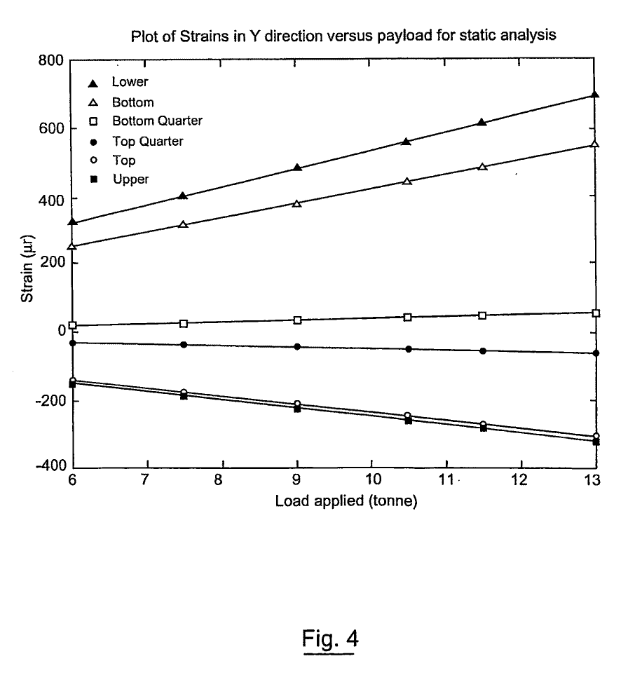

Static analysis in the range of expected axle loads showed a linear increase in strain, both in the vertical and longitudinal directions, with increasing payload. The strains versus payload in the longitudinal direction (X direction) and the vertical direction (Y direction) are shown in FIG. 3 and FIG. 4 respectively.

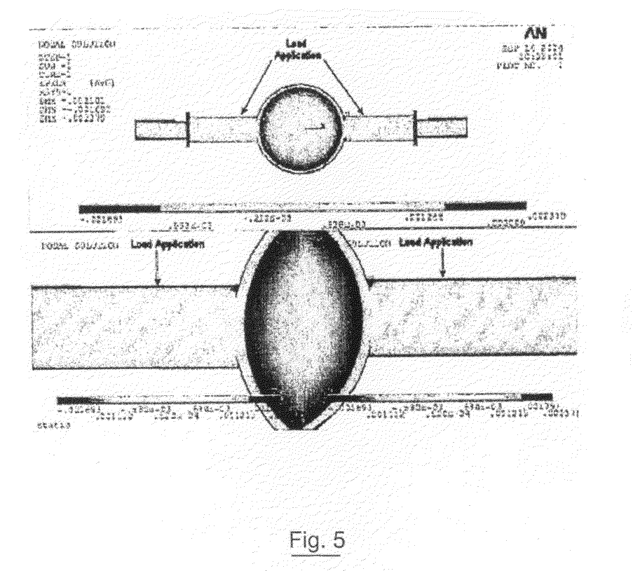

From these results the invention demonstrates that it is possible to determine the load from measurements of strain. Furthermore, when the model is an accurate representation of the actual axle, then it is possible to determine the load without calibration. FIG. 5 shows the strain levels in the longitudinal direction; the lower plot is a close up of the strain distribution at the bottom quarter points beneath the point of application of the load.

The model shows a higher magnitude of strain in the vertical direction than in the longitudinal direction e.g. 24.5 με/tonne for the bottom quarter point. Since the strain levels are low, it is important to site the strain transducers 2 at locations where the strain can be detected and measured most easily. This may indicate that the transducers 2 should be oriented in the vertical direction. However, the vertical sidewall suffers minor distortion as the load is increased. For this reason, if a strain transducer 2 is placed along the Y-axis in the vertical direction, it may detach when a curvature develops during distortion.

Thus the invention provides the surprising result that the strain transducers 2 should be oriented in the longitudinal direction. This is an important aspect of the invention.

The finite element (FE) model was validated experimentally by a series of laboratory tests. The axle was instrumented with strain gauges at locations indicated by the FE analysis. The objective of these tests was to ensure that predicted strain levels were correct and to verify or update the boundary conditions used for the FE model.

In an alternative embodiment of the invention, the master control unit 5 may be located at the central server remote from the HGV. In this case, the transmitter may be employed to transmit information on the longitudinal strains measured by the strain gauges 2 from the HGV to the central server. The calculation of the HGV load is then performed at the central server.

As an alternative to accessing the database or look-up table of load values versus strain values to calculate the vehicle load, the vehicle load may be calculated by means of a predetermined relationship between load and strain. This relationship may be obtained by performing a finite element analysis of the HGV axles 3, 4, for example prior to fitting of the system 1 to the HGV.

The finite element analysis is performed to find out the distribution of strain within the HGV axles 3, 4 and to find the optimum location of the strain transducers 2 to be placed, that is the locations where the strain is linearly related to load and where strain is sufficiently large to measure. The exact relationship between strain and force may be determined using the finite element analysis so that either an algebraic relationship between strain and force can be established or a look-up table (LUT) can be determined. In the first case, force will be determined by substituting actual strain values from a loaded axle into an equation to determine the force. In the second case, strain values will be used to interpolate within the LUT.

The finite element analysis is performed before installing the strain transducers 2.

Actual strain values may be input to the finite element analysis for verification but this would require off-line computation. This could be done if it was suspected that force measurements were unreliable. Both strain and calculated force values may be transmitted at regular intervals or on request.

The invention is not limited to the embodiment hereinbefore described, with reference to the accompanying drawings, which may be varied in construction and detail.

1-55. (canceled)

56. A system for determining a vehicle load, the system comprising:—
measuring means comprising at least one strain gauge configured to be mounted on at least one vehicle axle, to measure strain exerted on said at least one vehicle axle in a direction substantially parallel to the longitudinal axis of the at least one vehicle axle; wherein the measuring means is configured to be mounted at one or more locations on the at least one vehicle axle at which said axle exhibits a substantially linear strain-load relationship;
calculating means to calculate the vehicle load in response to the measured strain;
determining means configured to perform finite element analysis of a vehicle axle to determine one or more locations on a vehicle axle at which the vehicle axle exhibits a substantially linear strain-load relationship; and
wherein the determining means is configured to perform 3-D finite element modelling of a vehicle axle to determine strain distribution in the vehicle axle.

57. The system as claimed in claim 56, wherein the measuring means comprises a first strain gauge configured to be mounted on one side of a vehicle axle and a second strain gauge configured to be mounted on an opposite side of the vehicle axle.

58. The system as claimed in claim 56, wherein the measuring means is configured to measure the strain exerted on at least one axle of a moving vehicle, and the calculating means is configured to calculate the moving vehicle load.

59. The system as claimed in claim 56, wherein the measuring means is configured to measure in real-time strain exerted on at least one vehicle axle, and the calculating means is configured to calculate in real-time vehicle load.

60. The system as claimed in claim 56, wherein the measuring means is configured to measure strain exerted on at least one axle of a stationary vehicle, and the calculating means is configured to calculate the stationary vehicle load.

61. The system as claimed in claim 56, wherein the calculating means is configured to receive vehicle speed data and location data and for relating said data to load data.

62. The system as claimed in claim 61, wherein the calculating means is configured to calculate the vehicle load by means of a predetermined relationship between load and strain.

63. The system as claimed in claim 62, wherein the calculating means is configured to perform finite element analysis of a vehicle axle to obtain the relationship between load and strain.

64. The system as claimed in claim 56, wherein the calculating means is configured to calculate, responsive to the calculated vehicle load, the load exerted by a vehicle on a road surface.

65. The system as claimed in claim 56, wherein the calculating means is configured to be carried on board a vehicle, and to transmit information including vehicle load data from a vehicle to a location remote from the vehicle.

66. The system as claimed in claim 65, wherein the information includes vehicle speed information and vehicle location information.

67. The system as claimed in claim 56, wherein the calculating means is configured to be located remote from a vehicle, the system comprises a wireless transmitter for transmitting strain data, and the calculating means comprises a wireless interface to receive strain data.

68. The system as claimed in claim 56, wherein the measuring means comprises strain gauges configured for mounting on a plurality of vehicle axles.

69. A vehicle assembly comprising:—
a vehicle; and
a system for determining the vehicle load as claimed in claim 56.

70. A method of determining a vehicle load, the method comprising the steps of:—
measuring strain exerted on at least one axle of the vehicle; and
responsive to the measured strain, calculating the vehicle load,
wherein:
the strain exerted on the at least one vehicle axle in a direction substantially parallel to the longitudinal axis of the at least one vehicle axle is measured;
the method comprises the step of mounting a measuring means on the at least one vehicle axle;
the measuring means is mounted on the at least one vehicle axle at one or more locations on the at least one vehicle axle at which said axle exhibits a substantially linear strain-load relationship;
the method comprises the step of determining using finite element analysis the one or more locations on the at least one vehicle axle at which said axle exhibits a substantially linear strain-load relationship.

71. The method as claimed in claim 70, wherein the vehicle is moving; and wherein the strain exerted on the at least one vehicle axle is measured in real-time, and wherein the vehicle load is calculated in real-time.

72. The method as claimed in claim 70, wherein the vehicle is stationary.

73. The method as claimed in claim 70, wherein the vehicle load is calculated on board the vehicle.

74. The method as claimed in claim 70, wherein the vehicle load is calculated at a location remote from the vehicle.

75. The method as claimed in claim 70, wherein the method comprises the step of transmitting information from the vehicle to a location remote from the vehicle.

76. The method as claimed in claim 75, wherein measured strain information is transmitted.

77. The method as claimed in claim 75, wherein the vehicle load information is transmitted.

78. The method as claimed in claim 75, wherein vehicle speed and location information is transmitted.

79. The method as claimed in claim 70, wherein the vehicle load is calculated based on a finite element analysis of the at least one vehicle axle, and the vehicle load is calculated by accessing a predetermined database of load values versus strain values.

80. The method as claimed in claim 79, wherein the method comprises the step of performing a finite element analysis of the at least one vehicle axle to populate the database of load values versus strain values.

81. The method as claimed in claim 70, wherein the method comprises the step of calculating, responsive to the calculated vehicle load, the load exerted by the vehicle on a road surface.

82. The method as claimed in claim 70, wherein the measuring means measures strain in all vehicle axles.
